(19) United States
(12) Patent Application Publication
(10) Pub. No.: US 2015/0178798 A1
(43) Pub. Date: Jun. 25, 2015

(54) METHODS AND SYSTEMS FOR VALIDATING FEEDBACK RELATING TO CORPORATE VALUE STATEMENTS

(71) Applicant: Tim Garforth-Bles, Calgary (CA)

(72) Inventor: Tim Garforth-Bles, Calgary (CA)

(21) Appl. No.: 14/577,228

(22) Filed: Dec. 19, 2014

Related U.S. Application Data
(60) Provisional application No. 61/919,011, filed on Dec. 20, 2013.

(51) Int. Cl. G06Q 30/02

(52) U.S. Cl. CPC G06Q 30/0282

(57) ABSTRACT

Systems and methods are provided for validating corporate feedback from a plurality of users for at least one corporate value statement of one of a plurality of corporate entities. The system may present one or more corporate value statements for each corporate entity registered with the system for feedback by various users (e.g. consumer users and employee users). The feedback may include ratings, comments, reviews, and endorsements. The system may validate the feedback based on validating a user feedback token ID submitted with the feedback as being associated with the respective associated corporate entity. Based on the validation, the user feedback may be associated with the corporate entity associated with the feedback token ID, and an indication of the validated feedback may be presented.

### CROSS-REFERENCE TO RELATED APPLICATIONS

This application claims all benefits, including priority, to U.S. Provisional Patent Application Ser. No. 61/919,011, filed Dec. 20, 2013, the entirety of which is hereby incorporate by reference.

### FIELD OF THE INVENTION

The present invention relates generally to corporate feedback. The present invention further relates to methods and systems for validating corporate feedback.

### BACKGROUND OF THE INVENTION

Corporate values and standards are increasingly becoming more important to consumers and to corporate employees. Some corporations may not have a set of corporate values. Typically the more developed companies have service values and have found that by having values they can be true to their customers and employees.

A corporation may make its values and standards available through a corporate website, but these values may not be easy to find on the website given that the primary purpose and structure of a corporate website is typically to market products or services to consumers. A corporation may also provide a copy of its values within its physical premises with the expectation being for the employees to live up to those values.

Despite these efforts, a corporation's values may not be readily accessible to both consumers and employees, and even if accessible the values may not necessarily reflect the realities of the corporation's operations in practice. Accordingly, there is a need for greater accessibility of a corporation's values and also for verifying whether those values are being demonstrated by the corporation. There is also a need to determine whether the values of the corporation and the values of its employees coincide as greater alignment may assist the corporation in better achieving its goals.

### SUMMARY OF THE INVENTION

The present disclosure is related to methods and systems for displaying and validating a corporate entity's corporate value statements, which may include statements of corporate values or statements of corporate standards. In particular, the present disclosure describes methods and systems for validating values and standards by capturing feedback from a plurality of users regarding these corporate value statements using a computer server or servers. Optionally, both corporate employee users and customers or consumers of a particular corporation may provide support of these values and standards. The computer server may receive the feedback and may aggregate it and/or quantify a metric to determine and present an extent of the correspondence between the corporate value statement(s) of a particular corporate entity. As a plurality of corporate entities may register with the computer server, the corporate entities may then be ranked by the computer server in accordance with the determined correspondence for the respective corporate value statements with the user feedback received. The user feedback may also be controlled for each corporate entity by issuing at least one user feedback token identifier (“ID”) to a computing device associated with that corporate entity. The feedback token ID may then be distributed by the corporate entity to employees or customers, who may then submit feedback to the computer server of the present invention together with the feedback token ID in order for the computer server to validate the feedback as originating from a genuine employee or customer of the corporate entity, thereby reducing or eliminating feedback from users who are not true employees or customers of the corporate entity. The feedback therefore may be more readily relied upon as being an accurate reflection of experiences by the respective employees and customers in interacting with the respective corporate entity.

In accordance with an aspect of the present invention, there is provided a method, performed by at least one computer server, the method comprising: generating at least one unique feedback token identifier (“ID”) and associating each of the at least one feedback token ID with a respective one of a plurality of corporate entities; transmitting each of the at least one feedback token ID over at least one communications network to at least one remote computing device associated with the respective associated corporate entity; providing an indication of at least one corporate value statement associated with the respective associated corporate entity; receiving a plurality of instances of user feedback, each instance of user feedback originating from one of a plurality of user computing devices, each instance of the user feedback associated with one of the at least one corporate value statement, each instance of the user feedback comprising one of the at least one feedback token ID; for each instance of the user feedback, validating the received at least one feedback token ID as being associated with the respective associated corporate entity; based at least partly on the validation, associating each instance of the user feedback with the corporate entity associated with the received one of the at least one feedback token ID; and presenting an indication of the validated feedback of at least the corporate entity associated with the received one of the at least one feedback token ID.

In accordance with an aspect of the present invention, there is provided a system comprising a computer server comprising at least one data processor coupled to at least one non-transitory computer readable medium comprising processing instructions that when executed by the at least one data processor cause the at least one data processor to: generate at least one unique feedback token identifier (“ID”) and associate each of the at least one feedback token ID with a respective one of a plurality of corporate entities; transmit each of the at least one feedback token ID over at least one communications network to at least one remote computing device associated with the respective associated corporate entity; provide an indication of at least one corporate value statement associated with the respective associated corporate entity; receive a plurality of instances of user feedback, each instance of user feedback originating from one of a plurality of user computing devices, each instance of the user feedback associated with one of the at least one corporate value statement, each instance of the user feedback comprising one of the at least one feedback token ID; for each instance of the user feedback, validate the received at least one feedback token ID as being associated with the respective associated corporate entity; based at least partly on the validation, associate each instance of the user feedback with the corporate entity associated with the received one of the at least one feedback token ID; and present an indication of the validated feedback of at least the corporate entity associated with the received one of the at least one feedback token ID.

In accordance with an aspect of the present invention, there is provided a non-transitory computer readable medium comprising processing instructions that when executed by at least one data processor, cause the at least one data processor to: generate at least one unique feedback token identifier (“ID”) and associate each of the at least one feedback token ID with a respective one of a plurality of corporate entities; transmit each of the at least one feedback token ID over at least one communications network to at least one remote computing device associated with the respective associated corporate entity; provide an indication of at least one corporate value statement associated with the respective associated corporate entity; receive a plurality of instances of user feedback, each instance of user feedback originating from one of a plurality of user computing devices, each instance of the user feedback associated with one of the at least one corporate value statement, each instance of the user feedback comprising one of the at least one feedback token ID; for each instance of the user feedback, validate the received at least one feedback token ID as being associated with the respective associated corporate entity; based at least partly on the validation, associate each instance of the user feedback with the corporate entity associated with the received one of the at least one feedback token ID; and present an indication of the validated feedback of at least the corporate entity associated with the received one of the at least one feedback token ID.

In this respect, before explaining at least one embodiment of the invention in detail, it is to be understood that the invention is not limited in its application to the details of construction and to the arrangements of the components set forth in the following description or the examples provided therein, or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

In the drawings, embodiments of the invention are illustrated by way of example. It is to be expressly understood that the description and drawings are only for the purpose of illustration and as an aid to understanding, and are not intended as a definition of the limits of the invention.

FIG. 1 illustrates an exemplary representative system implementation of the present invention.

FIG. 2 illustrates an exemplary flow chart of the method of the present invention in accordance with an aspect of the present invention.

FIG. 3 illustrates an exemplary flow chart for registration of a corporate entity with the system of the present invention.

FIG. 4 illustrates an exemplary flow chart for modification of a corporate entity registration registered with the system of the present invention.

FIG. 5 illustrates an exemplary flow chart for submission and validation of employee feedback in accordance with an aspect of the present invention.

FIG. 6 illustrates an exemplary flow chart for submission and validation of customer feedback in accordance with an aspect of the present invention.

FIG. 7 illustrates an exemplary representative generic implementation of a computing device, such as a computer server, or a mobile computing device, according to the invention.

### DETAILED DESCRIPTION

In various aspects, the disclosure provides a computerized method, system, and computer readable medium for validating corporate feedback from a plurality of users for at least one corporate value statement of one of a plurality of corporate entities. The system may present one or more corporate value statements for each corporate entity registered with the system for feedback by various users (e.g. consumer users and employee users). The feedback may include ratings, comments, reviews, and endorsements. The system may validate the feedback based on validating a user feedback token ID submitted with the feedback as being associated with the respective associated corporate entity. Based on the validation, the user feedback may be associated with the corporate entity associated with the feedback token ID, and an indication of the validated feedback may be presented.

Optionally, the system of the present invention may aggregate the feedback by associating the feedback with at least one of the corporate value statements, and generating a score or metric for quantifying agreement or disagreement between each corporate value statement and the user feedback provided for that corporation. Optionally, the system may rank or group or sort at least a subset of the corporate entities registered with the system by their respective scores. Optionally, the system may also provide for modification of the listing of corporate entities and corporate values listed for each corporate entity.

For the purposes of this invention, a corporate entity may include any type of entity that employs staff or employees, for example, but not necessarily limited to, a corporation, a partnership, a business, a joint venture, a non-profit entity, a charity, municipal body, school group, health authority, regimental organizations, and any other type of public or private body or service. Unless explicitly stated to the contrary, any usage of any of these terms or of the term “corporate entity” is intended to cover any and all of the other listed terms for “corporate entity” as well.

The system of the present invention may provide for a plurality of corporate entities to be individually registered with the system in order for each registered corporate entity to present its respective corporate values to users.

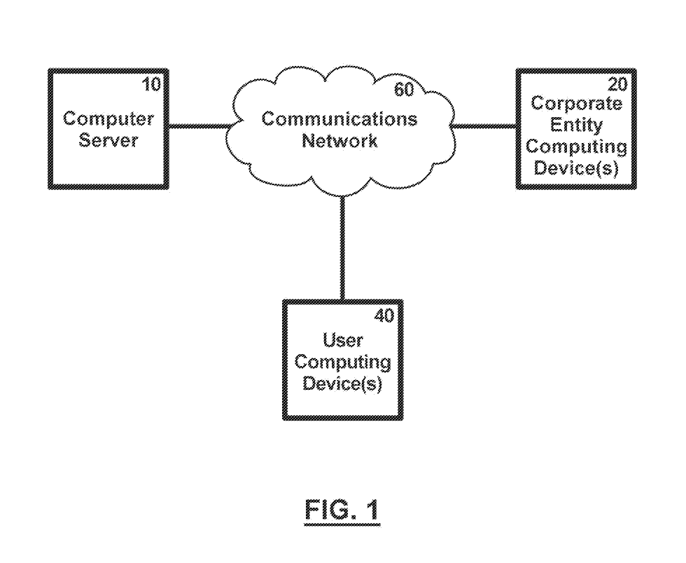

FIG. 1 illustrates a system view of the present invention, showing interconnectedness over at least one communications network 60 between at least one computer server 10, a plurality of computing device(s) 20 each associated with a respective corporate entity, and a plurality of user computing device(s) 40 each associated with a respective user. Computer server 10 may represent one or more computer servers or devices operating together or distinctly. In the case of multiple computer servers 10, each of the computer servers 10 may be configured to communicate with the other computer servers, or they may operate as one or more clusters of computers to implement the present invention. The at least one communications network 60 may include the Internet or other public communications network accessible to a variety of different user types. Optionally, the present invention may be implemented solely for internal use by a corporate entity or the corporate entity together with any of its subsidiaries. In such cases, the communications network 60 may be an intranet, virtual private network, or other private or secure network to allow only employee users to communicate with the computer server 10 for the purposes of the present invention.

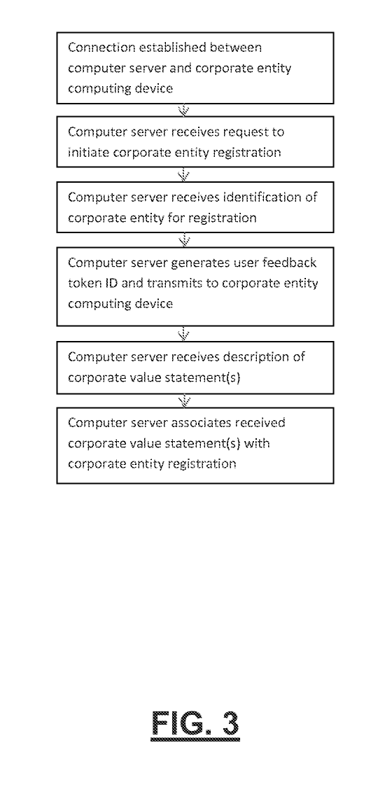

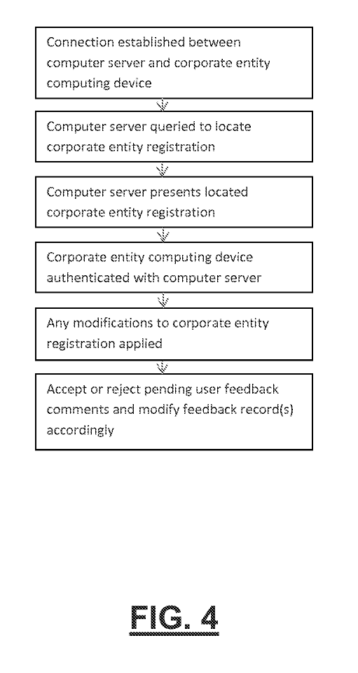

FIG. 3 illustrates a non-limiting exemplary method for registering a corporate entity with the system of the present invention. A representative of a corporate entity may communicate with the computer server 10 through one or more of the computing devices 20 in order to register the corporate entity with the computer server 10. A similar non-limiting exemplary process, shown in FIG. 4, may also be used to modify an existing corporate entity registration with the computer server 10. The registration process may include registering an identification of the corporate entity together with at least one corporate value statement which the computer server 10 may then associate with the registered corporate entity identification. The corporate entity identification may include a corporate name, corporate number, corporate logo, trademark, or other identifying representation of the corporate entity. The type of corporate entity may also be provided in the registration process in order to classify the corporate entity at the computer server 10. The registration may include creating, customizing, or otherwise configuring a web page for the corporate entity to be presented to users accessing the computer server 10 through respective user computing devices 40. The registration may also include configuring one or more login accounts for representatives of the corporate entity to use to modify the corporate entity registration. User feedback token IDs may be generated and provided to the corporate entity during the registration process. The user feedback token IDs may also or alternatively be generated upon request for a new code by the corporate entity subsequent to the corporate entity registration. For example, user feedback token IDs may be generated on an as needed basis upon receiving such a request from the corporate entity's computing device 20. The request may be a secure request transmitted over an encrypted channel using known secure communication techniques. The user feedback token IDs may also be transmitted to the corporate entity's computing device 20 over the secure channel or a separate secure channel.

The registration process may be implemented through a website operating on or otherwise controlled by or communicating with the computer server 10. Optionally, the registration process may occur through a computer software application operating on the computing device 20 such as an application for any one of a variety of computer operating systems, or as a mobile application where the computing device 20 is a mobile device. In any event, the application may communicate with the computer server 10 to achieve registration of the corporate entity with the computer server 10. Information included in the registration may include the corporate entity name, address, user name and password or other secure login credentials. Other information may also be included in the registration process, such as user feedback token identifiers, which are described in greater detail in this specification. The registration process may include submitting and associating one or more corporate value statements with the corporate entity identification. A corporate value statement may include one or more sentences or point form statements providing an indication of a value that the corporate entity wishes to associate with itself. A more abbreviated or simplified title for each corporate value statement may also be associated with each corporate value statement. Likewise, corporate mission statements and vision statements may also be associated with the corporate entity through the registration process.

Non-limiting examples of corporate value statements might include: “Company X strives to use only locally sourced organic produce”; “Company Y requires that all outsourced manufacturing be performed in accordance with workplace health and safety standards of the jurisdiction where Company Y's goods are sold”; or “Company Z has high customer satisfaction for its customer service.”

As shown in FIG. 4, a representative of the corporate entity may login to the computer server 10 to optionally review, revise or remove any of the information that was entered previously. The representative may be provided access to review unpublished comments that have been made by the employees or customers and be able to flag these comments for public posting at the representative's discretion. The corporate entity may optionally configure various promotions through the computer server 10 to offer promotions to users who have participated in the feedback process of the present invention. Notification of any such promotion may be made in an email confirmation to the employee or consumer after he or she has made an endorsement.

The system of the present invention may store each corporate entity registration as one or more entries in one or more databases of the computer server 10. The computer server 10 may provide public access to all or a subset of the information stored for each corporate entity, in the form of a website or the like, which may be accessed from a computing device such as a personal computer, laptop computer, mobile computing device, wearable computer, or any other type of computing device. The system may provide access through a web browser communicating with a particular website URL address or through an application, such a mobile application for a mobile wireless computing device.

For each corporate entity registered with the computer server 10, the system may generate and associate therewith at least one feedback token identifier (ID). The system may generate one token ID for each type of user, such as one token ID for employees of the corporate entity, and one token ID for customers of the corporate entity. Representatives of the corporation may then share the employee token ID with employees of the corporation, and may share the customer token ID with customers of the corporation. Sharing the customer token ID with customers may occur, for example, upon purchase by a customer of a product or service of the corporation. The token ID sharing may take the form of a code printed on a printed receipt or displayed in an electronic invoice. The token ID may be a plain text number, a barcode-readable number, a QR code, or may be stored in a secure storage, such as a secure element, of the receipt or card. Optionally, where the token ID is provided securely to the customer or employee user, it may be stored in a secure storage of the customer user's mobile computing device. Optionally, the token ID may be transmitted through near-field communications (“NFC”) at a checkout payment terminal of the corporate entity to a NFC-enabled mobile device of the user for storage, optionally in a secure element of the mobile device. The token ID may then be later retrieved when the mobile device interfaces directly with the computer server 10 over the communications network 60, or indirectly through an intermediary computer, optionally also through a NFC transmission between the mobile device and the intermediary computer for forwarding the token ID to the computer server 10. Optionally, the computer server 10 and the mobile device of the user may communicate securely in any one of a variety of known secure transmission protocols, including by using symmetric keys, public key infrastructure (“PKI”), session certificates, or other secure protocols or modes of communication.

In order to submit feedback for the particular corporate entity to the computer server 10, the employee or customer user may be required to input the specific token ID received for that corporate entity. The token ID may be validated by the computer server 10 as being previously associated with the respective corporate identity at the computer server 10. By restricting feedback access in this way, the feedback process may be better controlled by limiting feedback opportunities to only true customers or employees of the corporate entity, and not merely opening up feedback to the entire public. The feedback that is submitted and validated could therefore be more readily relied upon as being feedback from an genuine customer or employee of the corporate entity.

Optionally, the system may generate a unique token ID for each employee. Optionally, the system may generate a unique token ID for each customer of for each customer-based transaction. If an employee or customer token ID is shared amongst a larger group of people, the system may allow for the invalidation of some or all feedback received for that particular token ID, and any feedback access associated with the token ID may be revoked. For example, upon each customer-based transaction, a computer server of the corporate entity may securely communicate with the system of the present invention and request a new token ID for the transaction or customer. The system may authenticate the corporate computer server, generate a new token ID, associate the token ID with the corporate entity, and transmit the token ID to the corporate computer server for dissemination to the respective customer. The token ID may then be included in an electronic receipt for the customer-based transaction and delivered to the customer user via email, text message, or any other form of electronic or other communication.

Optionally, each token ID may be reusable or may be a single-use token, to expire after the successful submission of feedback comprising the single-use token. In such a case, where the single-use token is stored on a secure element of the user's mobile device, the computer server 10 may securely communicate to the mobile device to delete or mark as used the single-use token stored on the mobile device. Optionally, each token ID may set to expire after a predetermined time if the token ID is not used for feedback purposes with the system of the present invention.

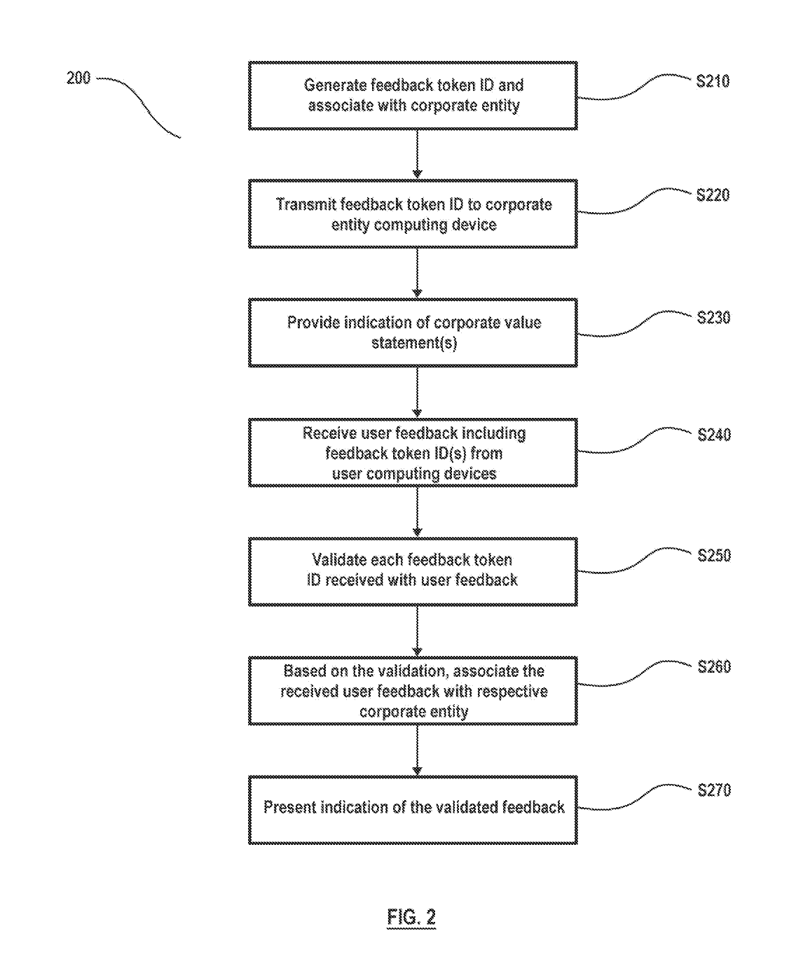

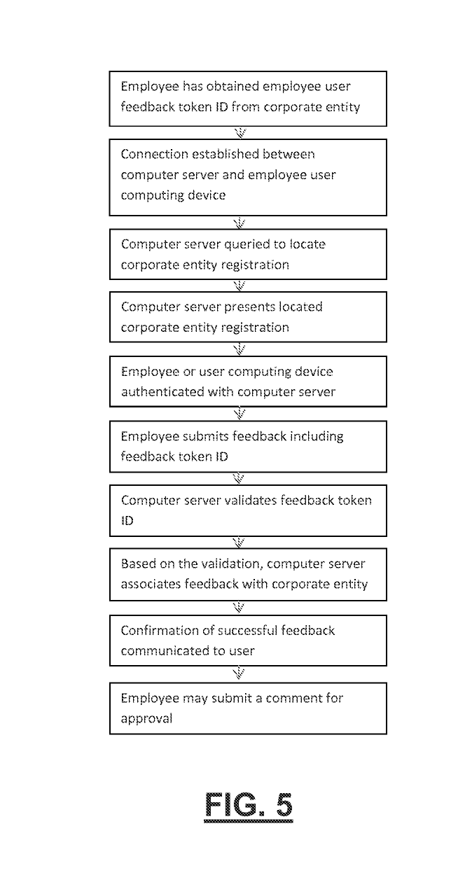

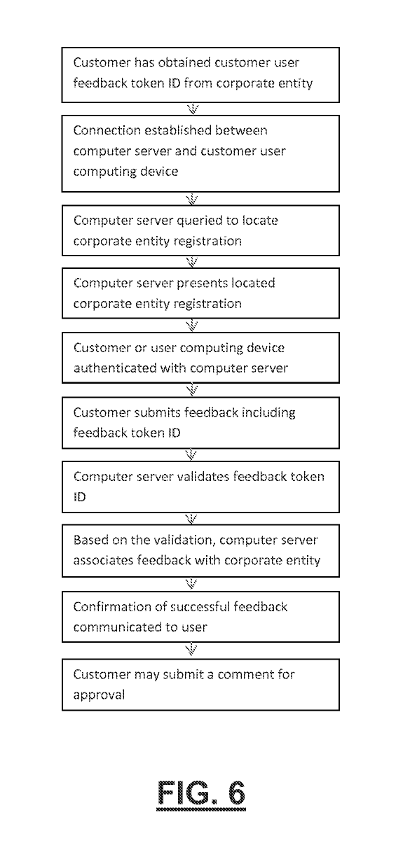

An exemplary, non-limiting implementation of the method 200 of the present invention is shown in FIG. 2, and particular non-limiting examples of employee feedback and customer feedback methods are shown in FIGS. 5 and 6, respectively. As explained, a user may receive a user feedback token ID from the corporate entity. At a step S210, the computer server 10 had generated the feedback token ID and associated it with the respective corporate entity at the computer server 10, possibly at the time of registration of the corporate entity with the computer server 10, or at a time thereafter. At a step S220, the computer server 10 transmitted the at least one feedback token ID to the corporate entity's computing device 20 associated with the respective corporate entity. In the case of an employee, the feedback token ID may be an employee-specific code. In the case of a customer, the feedback token ID may be a customer-specific code. For a code used by multiple users, the code may change periodically to reduce the likelihood of former employees leaving feedback or of customers sharing codes with non-customers. The user may optionally authenticate with the computer server 10 using a login process or other authentication process using the user's computing device 40. The authentication process may require registration by the user with the computer server 10, by registering a username, password, and email address. The token ID that the user possesses may also be communicated to the computer server 10 at login, or may be communicated later, upon leaving feedback. If the token ID is communicated at login, the computer server 10 may automatically validate the token ID as a non-expired token ID associated with a registered identification of a corporate entity, and if successfully validated may automatically present a feedback screen for that corporate entity. Otherwise, upon successful authentication, the computer server 10 may present a list of corporate entities registered with the computer server 10 or may allow the user to search for a particular corporate entity. The user may navigate the listing or search to locate the listing for the corporate entity. When located, at step S230, the computer server 10 may provide an indication of one or more corporate value statements registered with the computer server 10 by displaying or causing to be displayed an entry for the respective corporate entity, including any associated corporate value statements, or any other publicly-available information of the corporate entity made available at the computer server 10. At step S240, the user may then provide the token ID and leave feedback for a particular corporate value statement. Optionally, the user may leave additional general feedback or comments, which may be moderated for publication by the corporate entity. At step S250, the computer server 10 validates the token ID received either with the feedback or earlier, upon user authentication with the computer server 10. The computer server 10 may validate the feedback token ID as being non-expired and being associated with the corporate entity for which feedback is being submitted. When feedback is successfully submitted and validated, at step S260, the computer server 10 may associate the user feedback with the corporate entity associated with the received feedback token ID. At step S270, the computer server 10 may present an indication of the validated feedback of the corporate entity by displaying, or causing to be displayed, the validated feedback at the user's computing device 40. The user may also be notified of the successful validated feedback submission by receiving an email or other type of communication from the computer server 10. The computer server 10 may also communicate to the corporate entity, optionally through the corporate entity's computing device that validated feedback has been submitted. In the case of an employee user, the notification sent to the user immediately after submitting validated feedback may reinforce the employee's commitment to the corporate entity and offer the employee one or more promotions that would otherwise not be available to the employee.

When leaving feedback, the system of the present invention may present an indication of the validated feedback of at least the corporate entity associated with the received feedback token ID. The presented indication may take the form of displaying the validated feedback on a display device of the user's computing device.

In general, the system and method of the present invention comprises at least one computer server 10 generating at least one unique feedback token identifier (“ID”) and associating each of the at least one feedback token ID with a respective one of a plurality of corporate entities. The at least one computer server 10 may transmit each of the at least one feedback token ID over at least one communications network to at least one remote computing device 20 associated with the respective associated corporate entity. The at least one computer server 10 may provide an indication of at least one corporate value statement associated with the respective associated corporate entity. The at least one computer server 10 may receive a plurality of instances of user feedback, each instance of user feedback originating from one of a plurality of user computing devices, each instance of the user feedback associated with one of the at least one corporate value statement, each instance of the user feedback comprising one of the at least one feedback token ID. The at least one computer server 10 may, for each instance of the user feedback, validate the received at least one feedback token ID as being associated with the respective associated corporate entity. Based at least partly on the validation, the at least one computer server 10 may associate each instance of the user feedback with the corporate entity associated with the received one of the at least one feedback token ID, and present an indication of the validated feedback of at least the corporate entity associated with the received one of the at least one feedback token ID.

Optionally, the at least one unique feedback token ID may comprise at least one employee feedback token ID and at least one customer feedback token ID each associated with the respective one of the plurality of corporate entities.

In the case of employee feedback, an employee user may submit feedback for a particular corporation and submit a token ID with the feedback. This may allow the system to identify the user as an employee of the corporation without the employee having to specifically identify himself or herself to the system. The system of the present invention may validate the at least one feedback token ID as an employee feedback token ID, and based at least partly on the validation, classify the instance of user feedback as employee feedback. Any presented indications of validated employee feedback may also be presented distinctly from any other feedback types for the respective corporate entity. The employee feedback may therefore be anonymized while still determining that the feedback user is an employee. Optionally, a token ID may be generated for and associated with each employee of the corporation, so that individual employees may be identified. When a particular employee submits feedback to the system using the individualized employee-specific token ID, the system may communicate this to one or more computing devices 20 associated with the respective corporate entity for the purposes of the computing device 20 generating and/or transmitting an email to the employee. The email may include various reward or coupon codes, or other incentives as an incentive for providing feedback for the employee's corporate entity. Alternatively, the system of the present invention may also have access to the employee's email address, either through employee user registration, or by obtaining the email address from the corporate entity, and may email the employee directly. Information regarding which employees have submitted feedback, or an anonymized feedback rate amongst all employees, may also be determined by the system for presentation to the corporate entity, optionally by transmitting this information to the corporation's computer server.

In an era when buy-in and accountability are of paramount importance, the system of the present invention may provide a publicly accessible service where a plurality of companies can each publicize and extol the corporate values through the same service. A corporation may not encourage representation of the corporation by its employees on social networking services, as social networking services are not equipped to verify which users are employees of the corporation, nor are social networking services structured for the purposes of listing and providing feedback on specific corporate values. Through the user of the employee token IDs described herein, the system of the present invention may allow employees the opportunity to leave anonymized or tracked employee feedback regarding specific corporate values articulated by the corporate entity. While a corporation may not desire its employees to provide commentary on a wide variety of topics specific to the corporation, it may be desirable for the corporation to receive employee feedback on specific corporate values that the corporation is attempting to implement. The system of the present invention may provide for such targeted employee feedback.

Through the feedback received through the system of the present invention, the corporation may also be assisted in developing or refining corporate values or standards that are more applicable to the corporation's business. The employees of the corporation may also achieve increased awareness of the corporation's values when having to think about and comment on them. This increased awareness may also result in increased employee performance. Furthermore, the system of the present invention may assist the employees in understanding whom it is they are working for and what they stand for. Furthermore, it may assist the company and the consumer in the knowledge that they are aligned in their beliefs. The ensuing competitive results may generate more accountability and increased performance for corporations.

For employee feedback, it may be useful for employees to interact with the system of the present invention to view in one place, open to the public, the support their company has for its values and to see who supports the values. A well-managed company with achievable service values may operate as one unit and in this case employees may benefit by endorsing the values and completing that feeling of belonging to good organization, working for the right company. Employees may gain a positive feeling of “team spirit”. Employees may also submit specific comments with their feedback. Any such comments may be made available for viewing by the corporate entity and may be kept confidential unless toggled for public display by a representative of the corporate entity. By accessing the system of the present invention, at the outset a potential employee may be able to see the validated values of an employer and decide whether or not those values are compatible with the potential employee.

With regards to consumers, customers, or potential customers of a corporate entity, it may be important to the consumer to know that the corporate entity endeavors to exhibit particular values and attempts to live up to those values. For example, it may be important to a consumer that the corporation supports environmentally conscious production practices, or that employee working conditions meet certain standards. The system of the present invention may provide a mechanism to provide validated corporate values for a variety of corporate entities, and particularly for employees to confirm that internal practices of the corporate entity are consistent with the image of the corporate entity presented publicly by the corporate entity itself.

The feedback provided for each corporate entity may also expire after a predetermined length of time, such as 6 months after submission and validation. New feedback may also be submitted at any time, allowing for dynamically updated determinations of correspondence between the corporate entity's corporate value statements and the realities experienced by users leaving feedback. This may be particularly important where the standards for a corporate entity have changed, possibly due to management change, a change in market conditions, or other factors. For example, where a corporate entity that has a monopoly over a market suddenly changes a service plan to give it an unfair advantage, it may be useful to users to have this change be reflected in the validated feedback presented on the system of the present invention. Optionally, the computer server 10 may be configured to send an alert, or present an alert page to alert visiting users when a corporate entity registered with the system has breached a corporate value statement registered with the system.

An example of the customer feedback process is shown in FIG. 6. As in the previously described cases, after authenticating to the computer server 10 and locating the corporate entity for feedback purposes, the customer may submit the user feedback token ID, which the customer user would have received previously from the corporate entity, and optionally the user's email address. The customer user may then proceed to leave feedback for a presented corporate value statement (endorse a company value). The system of the present invention may validate the at least one feedback token ID as a customer feedback token ID, and based at least partly on the validation, classify the instance of user feedback as customer feedback. Any presented indications of validated customer feedback may also be presented distinctly from any other feedback types for the respective corporate entity. The system may be configured to associate a predefined expiry time with the feedback, as it may be expected that the customer revisit the website to ensure support of the company values. The user feedback token ID is also validated as previously described. The customer user may be contacted by email from the computer server 10 or the corporate entity after endorsing a corporate value statement. This email may reinforce their commitment to the company and offer them promotions that they would otherwise be unable to obtain. Consumers may also be able to leave comments for review by the company. Consumers may also be offered a locating service to find companies in their area.

The consumer today is largely at the mercy of companies and their values. For example, eating at a restaurant on a bad night when the food and service was below standard. The system of the present invention may inform the user as to what steps did the restaurant take to make it right for the customer and make the customer want to go back there to eat there again. For example, buying faulty merchandise whether or not it was under warranty. The system of the present invention may inform the user as to how did that company deal with the problem to make the customer feel as though they went the extra mile and there was no loss on the customer's behalf. Other examples may include customer feedback for a builder that doesn't follow through on the builder's promise, or a landscaping company that leave the premises in disarray.

The system of the present invention may allow for registered corporate entities to be presented to a user based on the positivity or negativity of the validated submitted feedback, or by proximity to the user or to a given geographic area. For example, vendors with “good” validated feedback in a particular area may be recommended to the user. For example, if the user is looking for a certain type of restaurant, the user may query the system of the present invention for good restaurants of that type within 1 km of the user's present location, which may be shared with the system through the user's mobile device. For example, grocery stores that have been verified as caring about local food producers, family needs, or pricing may be presented to the user accordingly. For example, a bank where good customer service has been validated may be presented to the user accordingly. For example, a travel agent that has been validated to organize vacations and basic requirements may be presented to the user accordingly.

The system of the present invention may further provide various comparisons between corporate entities registered with the system. For example, to the extent certain metrics may be quantified, such as how “green” a corporate entity's operations are, the system of the present invention may be able to present a dynamically updated ranking of the registered corporate entities based on this metric.

User feedback submitted to the system of the present invention may take the form of a comment associated with a respective corporate value statement of a corporate entity, or may be an indication of a level of agreement with the content of the corporate value statement. For example, the user may be presented with an option to either agree or disagree with the corporate value statement. For example, the user may be presented with an option to strongly agree, agree, be indifferent to, disagree, or strongly disagree with the corporate value statement. For example, the user may provide a numerical or letter score or grade with respect to each corporate value statement, such as “A+ for customer service, C for food quality”. In any of these cases, or in any instance of leaving feedback that is not purely comment-based, the system of the present invention may attempt to aggregate that feedback with other existing feedback stored in the system for the same corporate value statement of the same corporate entity. For example, where a plurality of users have provided ratings for a particular corporate value statement, the system may average those ratings to determine an aggregated average endorsement rating for the particular corporate value statement. Optionally, the system may be configured to weight more recent feedback more strongly than older feedback in the aggregation to skew the aggregated average endorsement rating in favor of more recently submitted validated user feedback.

Where users leave feedback in a variety of rating types, or where the feedback is not immediately displayable in a quantified format, the system of the present invention may also attempt to quantify the feedback to thereby produce an aggregated quantified metric of the level of agreement between the validated feedback left by the plurality of users and the associated corporate value statement. For example, the system may be configured to present endorsement ratings from 0% to 100% for each corporate value statement. Where a user submits a rating of “A+”, the system may be configured to automatically quantify the submitted rating to a score of 95. Optionally, where the submitted feedback is purely comment-based without a specific rating, the system may be configured to parse the comment for particular keywords, the system having been preconfigured with a lexicon of keywords that are each associated with a numerical rating. The system may then attempt to quantify a rating metric or score for the comment where none was provided by the user by performing a calculation based on the identified known keywords and their respective associated ratings. For example, the words “greatest”, “best”, “excellent”, and “happy” may be associated with high numerical ratings, while the words “worst”, “terrible”, and “never again” may be associated with low numerical ratings. Based on the outcome of this quantification, the system may associate a rating with the user's comment. The system may optionally present this determined rating to the user for user approval prior to associating the rating with the comment, or the system may simply associate the rating with the comment without the user's approval. The quantified rating may then become aggregated with the other quantified ratings for the corporate value statement stored in the system, and an ultimate aggregated quantified metric corresponding to the level of agreement between the validated feedback and the associated one of the at least one corporate value statement may be presented or presentable to the user.

Furthermore, the results of the aggregation and quantification may be compared in a variety of means, including, optionally, by measurement using a business matrix where the outcome may be a determination of a corporate entity's competitive standing in its field (e.g. with respect to customer service), in its industry (e.g. tourism) and overall performance as it relates to the support of these values and standards. The system may rank or group or sort at least a subset of the corporate entities registered with the system by their respective aggregated quantified scores. The ranked corporate entities may further be filtered by field, geographic location, service offerings, or by other criteria. Optionally, the system may present an indication of the validated feedback of at least a subset of the registered corporate entities ranked by numerous metrics, including: respective associated measure of market share; respective associated measure of stock value; respective associated measure of popularity; respective associated measure of corporate size.

The system, method, and computer readable medium of the present invention must be implemented by one or more computers as the solution relies upon inter-computer communication, authentication, and validating of feedback token identifiers shared between computer servers, corporate computing devices, and user computing devices for corporate entities and users which may be located at disparate locations around the world. Dynamically updating validated feedback for registered corporate entities of the system of the present invention would also not be feasible unless implemented on computing devices, as described herein.

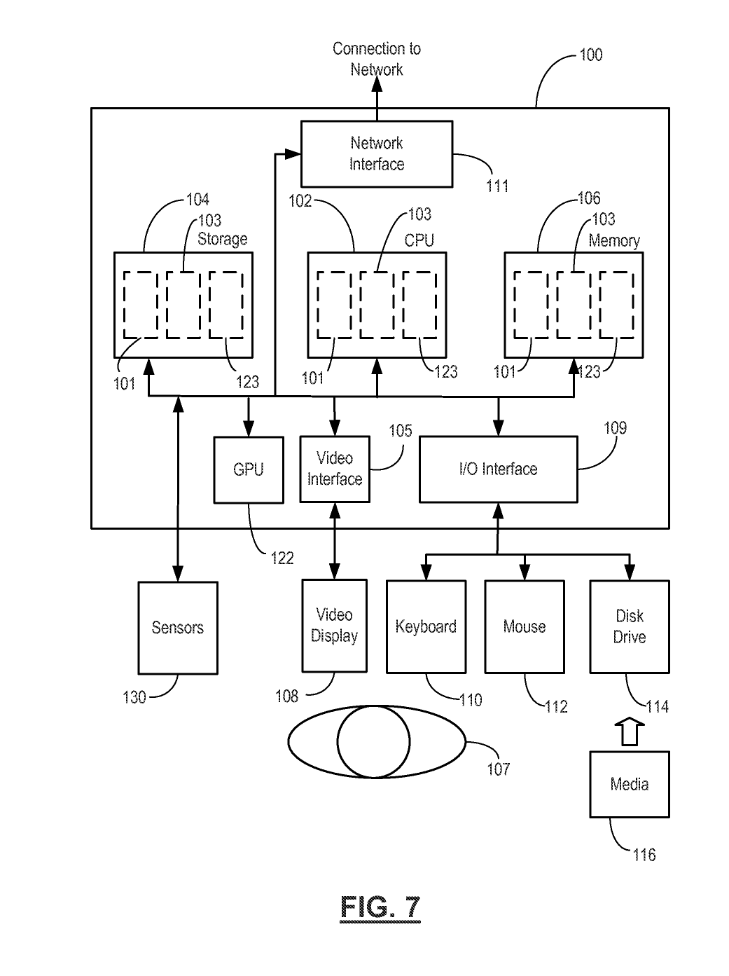

The present system and method may be practiced in various embodiments. A suitably configured computer device, and associated communications networks, devices, software and firmware may provide a platform for enabling one or more embodiments as described above. By way of example, FIG. 7 shows a generic computer device 100 that may include a central processing unit (“CPU”) 102 connected to a storage unit 104 and to a random access memory 106. The CPU 102 may process an operating system 101, application program 103, and data 123. The operating system 101, application program 103, and data 123 may be stored in storage unit 104 and loaded into memory 106, as may be required. Computer device 100 may further include a graphics processing unit (GPU) 122 which is operatively connected to CPU 102 and to memory 106 to offload intensive image processing calculations from CPU 102 and run these calculations in parallel with CPU 102. An operator 107 may interact with the computer device 100 using a video display 108 connected by a video interface 105, and various input/output devices such as a keyboard 110, mouse 112, and disk drive or solid state drive 114 connected by an I/O interface 109. In known manner, the mouse 112 may be configured to control movement of a cursor in the video display 108, and to operate various graphical user interface (GUI) controls appearing in the video display 108 with a mouse button. The disk drive or solid state drive 114 may be configured to accept computer readable media 116. The computer device 100 may form part of a network via a network interface 111, allowing the computer device 100 to communicate with other suitably configured data processing systems (not shown). One or more different types of sensors 130 may be used to receive input from various sources. The video display 108 may be used to display video data signals such as streaming video of a video call received at the communications device.

The present system and method may be practiced on virtually any manner of computer device including a desktop computer, laptop computer, tablet computer or wireless handheld. The present system and method may also be implemented as a computer-readable/useable medium that includes computer program code to enable one or more computer devices to implement each of the various process steps in a method in accordance with the present invention. In case of more than computer devices performing the entire operation, the computer devices are networked to distribute the various steps of the operation. It is understood that the terms computer-readable medium or computer useable medium comprises one or more of any type of physical embodiment of the program code. In particular, the computer-readable/useable medium can comprise program code embodied on one or more portable storage articles of manufacture (e.g. an optical disc, a magnetic disk, a tape, etc.), on one or more data storage portioned of a computing device, such as memory associated with a computer and/or a storage system.

The mobile application of the present invention may be implemented as a web service, where the mobile device includes a link for accessing the web service, rather than a native application.

The functionality described may be implemented to any platform, including mobile platforms such as the iOS platform, ANDROID™, WINDOWS™ or BLACKBERRY™.

It will be appreciated by those skilled in the art that other variations of the embodiments described herein may also be practiced without departing from the scope of the invention. Other modifications are therefore possible.

In further aspects, the disclosure provides systems, devices, methods, and computer programming products, including non-transient machine-readable instruction sets, for use in implementing such methods and enabling the functionality described previously.

Although the disclosure has been described and illustrated in exemplary forms with a certain degree of particularity, it is noted that the description and illustrations have been made by way of example only. Numerous changes in the details of construction and combination and arrangement of parts and steps may be made. Accordingly, such changes are intended to be included in the invention, the scope of which is defined by the claims.

Except to the extent explicitly stated or inherent within the processes described, including any optional steps or components thereof, no required order, sequence, or combination is intended or implied. As will be will be understood by those skilled in the relevant arts, with respect to both processes and any systems, devices, etc., described herein, a wide range of variations is possible, and even advantageous, in various circumstances, without departing from the scope of the invention, which is to be limited only by the claims.

What is claimed is:

1. A method, performed by at least one computer server, the method comprising:
generating at least one unique feedback token identifier (“ID”) and associating each of the at least one feedback token ID with a respective one of a plurality of corporate entities;
transmitting each of the at least one feedback token ID over at least one communications network to at least one remote computing device associated with the respective associated corporate entity;
providing an indication of at least one corporate value statement associated with the respective associated corporate entity;
receiving a plurality of instances of user feedback, each instance of user feedback originating from one of a plurality of user computing devices, each instance of the user feedback associated with one of the at least one corporate value statement, each instance of the user feedback comprising one of the at least one feedback token ID;
for each instance of the user feedback, validating the received at least one feedback token ID as being associated with the respective associated corporate entity;
based at least partly on the validation, associating each instance of the user feedback with the corporate entity associated with the received one of the at least one feedback token ID; and
presenting an indication of the validated feedback of at least the corporate entity associated with the received one of the at least one feedback token ID.

2. The method of claim 1 wherein the at least one unique feedback token ID comprises at least one employee feedback token ID and at least one customer feedback token ID each associated with the respective one of the plurality of corporate entities.

3. The method of claim 2 wherein the received at least one feedback token ID comprises the at least one employee feedback token ID, the validating comprises validating the at least one feedback token ID as an employee feedback token ID, and based at least partly on the validation, classifying the instance of user feedback as employee feedback; wherein the presenting comprises presenting an indication of the validated employee feedback for each of the plurality of corporate entities distinct from any other feedback type for the respective corporate entity.

4. The method of claim 2 wherein the received at least one feedback token ID comprises the at least one customer feedback token ID, the validating comprises validating the at least one feedback token ID as a customer feedback token ID, and based at least partly on the validation, classifying the instance of user feedback as customer feedback; wherein the presenting comprises presenting an indication of the validated customer feedback for each of the plurality of corporate entities distinct from any other user feedback type for the respective corporate entity.

5. The method of claim 1 comprising aggregating the validated feedback for the corporate entity associated with the received one of the at least one feedback token ID; and wherein the presenting comprises presenting an indication of the aggregated validated feedback for at least the corporate entity associated with the received one of the at least one feedback token ID.

6. The method of claim 5 wherein the aggregating comprises quantifying at least a part of the validated feedback and producing an aggregated quantified metric corresponding to a level of agreement between the validated feedback and the associated one of the at least one corporate value statement; and wherein the presenting comprises presenting an indication of the aggregated quantified metric for at least the corporate entity associated with the received one of the at least one feedback token ID.

7. The method of claim 6 wherein the presenting comprises presenting a list of at least a subset of the plurality of corporate entities ranked in an order in accordance with the aggregated quantified metric.

8. The method of claim 1 wherein the presenting comprises presenting an indication of the validated feedback of at least a subset of the plurality of corporate entities ranked by a respective associated measure of market share.

9. The method of claim 1 wherein the presenting comprises presenting an indication of the validated feedback of at least a subset of the plurality of corporate entities ranked by a respective associated measure of stock value.

10. The method of claim 1 wherein the presenting comprises presenting an indication of the validated feedback of at least a subset of the plurality of corporate entities ranked by a respective associated measure of popularity.

11. The method of claim 1 wherein the presenting comprises presenting an indication of the validated feedback of at least a subset of the plurality of corporate entities ranked by a respective associated measure of corporate size.

12. The method of claim 1 wherein the presenting an indication comprises displaying on a display device of one of the plurality of user computing devices the validated feedback of at least the corporate entity associated with the received one of the at least one feedback token ID.

13. The method of claim 2 wherein each of the at least one employee feedback token ID is uniquely associated with an individual employee.

14. The method of claim 2 wherein each of the at least one customer feedback token ID is uniquely associated with an individual customer.

15. A system comprising a computer server comprising at least one data processor coupled to at least one non-transitory computer readable medium comprising processing instructions that when executed by the at least one data processor cause the at least one data processor to:
generate at least one unique feedback token identifier (“ID”) and associate each of the at least one feedback token ID with a respective one of a plurality of corporate entities;
transmit each of the at least one feedback token ID over at least one communications network to at least one remote computing device associated with the respective associated corporate entity;
provide an indication of at least one corporate value statement associated with the respective associated corporate entity;
receive a plurality of instances of user feedback, each instance of user feedback originating from one of a plurality of user computing devices, each instance of the user feedback associated with one of the at least one corporate value statement, each instance of the user feedback comprising one of the at least one feedback token ID;
for each instance of the user feedback, validate the received at least one feedback token ID as being associated with the respective associated corporate entity;
based at least partly on the validation, associate each instance of the user feedback with the corporate entity associated with the received one of the at least one feedback token ID; and
present an indication of the validated feedback of at least the corporate entity associated with the received one of the at least one feedback token ID.

16. The system of claim 15 wherein the at least one unique feedback token ID comprises at least one employee feedback token ID and at least one customer feedback token ID each associated with the respective one of the plurality of corporate entities.

17. The system of claim 15 wherein the processing instructions when executed by the at least one data processor cause the at least one data processor to: aggregate the validated feedback for the corporate entity associated with the received one of the at least one feedback token ID; and wherein the presenting comprises presenting an indication of the aggregated validated feedback for at least the corporate entity associated with the received one of the at least one feedback token ID.

18. A non-transitory computer readable medium comprising processing instructions that when executed by at least one data processor, cause the at least one data processor to:
generate at least one unique feedback token identifier (“ID”) and associate each of the at least one feedback token ID with a respective one of a plurality of corporate entities;
transmit each of the at least one feedback token ID over at least one communications network to at least one remote computing device associated with the respective associated corporate entity;
provide an indication of at least one corporate value statement associated with the respective associated corporate entity;
receive a plurality of instances of user feedback, each instance of user feedback originating from one of a plurality of user computing devices, each instance of the user feedback associated with one of the at least one corporate value statement, each instance of the user feedback comprising one of the at least one feedback token ID;
for each instance of the user feedback, validate the received at least one feedback token ID as being associated with the respective associated corporate entity;
based at least partly on the validation, associate each instance of the user feedback with the corporate entity associated with the received one of the at least one feedback token ID; and
present an indication of the validated feedback of at least the corporate entity associated with the received one of the at least one feedback token ID.

19. The non-transitory computer readable medium of claim 18 wherein the at least one unique feedback token ID comprises at least one employee feedback token ID and at least one customer feedback token ID each associated with the respective one of the plurality of corporate entities.

20. The non-transitory computer readable medium of claim 18 wherein the processing instructions when executed by the at least one data processor cause the at least one data processor to: aggregate the validated feedback for the corporate entity associated with the received one of the at least one feedback token ID; and wherein the presenting comprises presenting an indication of the aggregated validated feedback for at least the corporate entity associated with the received one of the at least one feedback token ID.
